(19) United States
(12) Patent Application Publication
(10) Pub. No.: US 2016/0173897 A1
(43) Pub. Date: Jun. 16, 2016

(54) High Parallelism Dependency Pattern for GPU Based Deblock

(71) Applicants: Haihua Wu, San Jose, CA (US); Julia A. Gould, San Jose, CA (US)

(72) Inventors: Haihua Wu, San Jose, CA (US); Julia A. Gould, San Jose, CA (US)

(21) Appl. No.: 14/565,555

(22) Filed: Dec. 10, 2014

(51) Int. Cl. H04N 19/436; H04N 19/18; H04N 19/176; H04N 19/182; H04N 19/86; H04N 19/119

(52) U.S. Cl. CPC H04N 19/436; H04N 19/865; H04N 19/119; H04N 19/176; H04N 19/182; H04N 19/18

(57) ABSTRACT

A thread dependency scheme may significantly reduce the dependency penalty and improve the parallelism efficiency in some embodiments in video compression techniques with relatively high dependencies, such as VP9. One fundamental feature is to split an individual large kernel into multiple, less dependent, smaller kernels, thereby significantly increasing the number of software threads that can potentially run in parallel. Another feature is to define the larger number of thread dependencies (superset of all the dependency candidates for each thread), with the specific thread's spatial position and associated context, and mask out some of the unnecessary thread dependencies.

### BACKGROUND

VP9 is a leading video compression standard proposed by Google, experiencing growing popularity on Internet media applications, including streaming video and video conferencing. VP9 works on superblocks of 64×64 pixels. VP9's deblock module reduces blockiness artifacts on superblocks by filtering vertical edges first and horizontal edges second.

VP9's deblock module consumes a large part of the computation cost in traditional software implementations due to its high dependency on neighboring results. More specifically, threads need to wait for execution of threads for adjacent blocks before they can complete execution using the results of execution by those adjacent threads. With traditional graphics processing unit (GPU) implementations, the computation parallelism efficiency is very poor because of the VP9 deblock module's new spatial dependency pattern.

### BRIEF DESCRIPTION OF THE DRAWINGS

Some embodiments are described with respect to the following figures:

FIG. 1 shows a wavefront 26 dependency according to one embodiment;

FIG. 2 shows a superblock's deblock edge and its closest neighbor, according to one embodiment;

FIG. 3 shows a dependency pattern for each edge according to one embodiment;

FIG. 4 shows a 64×64 pixel superblock split into 128 smaller threads according to one embodiment;

FIG. 5 shows seven dependency candidates for one embodiment;

FIG. 6 shows a dependency cut with transform unit (TU) size information according to one embodiment;

FIG. 7 is a flow chart for one embodiment;

FIG. 8 is a schematic depiction of one embodiment; and

FIG. 9 is a front elevation of a system according to one embodiment.

### DETAILED DESCRIPTION

A thread dependency scheme may significantly reduce the dependency penalty and improve the parallelism efficiency in some embodiments in video compression techniques with relatively high dependencies, such as VP9. This method may be applied as a graphics processing unit (GPU) software solution or a fixed function hardware solution, as two embodiments.

An individual large kernel may be split into multiple, less dependent, smaller kernels, thereby significantly increasing the number of software threads that can potentially run in parallel. Another feature is to define the larger number of thread dependencies (superset of all the dependency candidates for each thread), with the specific thread's spatial position and associated context, and mask out some of the unnecessary thread dependencies.

With more complicated dependency patterns, in the traditional GPU software implementation, each thread processes a larger (e.g. 64×64) pixel block data area and handles both vertical and horizontal edge deblock in one kernel. It is not possible to separate the vertical edge and horizontal edge deblock on a 64×64 pixel block as they are mutually dependent. Each kernel has a left, top-left, top, and top-right spatial result dependency.

For a full high definition (1920×1080) resolution picture, the peak parallel thread number is only 15 along the diagonal. This number is much smaller than the maximum number of hardware threads available on popular GPU systems. Considering that ramp-up and cool-down stages are needed for a real system, the average parallel thread number is much less than the peak number. So the real usage of execution unit (EUs) is very poor for VP9 deblock modules.

In the following discussion an example using VP9 is provided but the principles also apply to any deblock module with relatively complex dependency patterns, arising from the use of relatively larger block sizes.

To address these issues, the 64×64 pixel data area may be split into many smaller threads, (i.e. 64 vertical edge deblock threads and 64 horizontal edge deblock threads, for a total of 128 threads). Compared to the traditional VP9's 4 dependency directions (left, top-left, top, top-right), this approach increases the total dependency candidate's directions from 4 to 7. Though the total number of dependency directions is 7, with a specific thread's context, one can further mask out some of the dependencies, so that as few as 3 out of 7 dependencies are needed for a specific thread in some embodiments.

A media pipeline may use scoreboarding to enforce thread dependency. Each thread has an associated (X,Y) coordinate within the thread space. Each thread may have up to eight dependencies. The dependency relation is described by the relative distance (deltaX, deltaY) in the scoreboard. Wavefront 26-degree dependency is an example. This pattern has four dependencies, in terms of (deltaX, deltaY), (−1,0) (−1,−1) (0,−1) and (1,−1). Each thread has a dependency with the thread directly to its left, left above, directly above, and to its upper right. This results in waves of threads that can run concurrently.

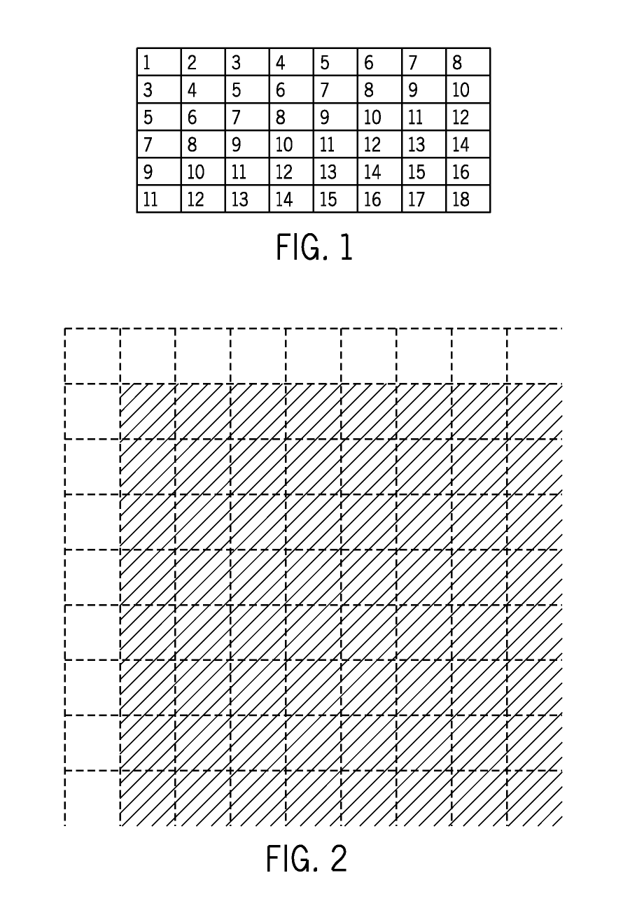

FIG. 1 illustrates this 26-degree dependency wherein the boxes are threads and the numbers represent thread execution order. The wavefront 26-degree arises from the angle across the grid shown in FIG. 1 of the set of threads that can run in parallel. FIG. 1 shows a thread execution order, where the number represents a thread execution order, each block representing a thread. Only 48 of 128 threads are shown in FIG. 1. So the box labeled 1 at the upper left corner represents a thread that executes first, then box 2 to the right executes, then the boxes labeled 3 can execute, in parallel, two at a time.

In the 26-degree wavefront dependency pattern, a thread may be dependent on the threads to its upper left, directly above, upper right and directly to its left.

So in FIG. 1, the thread 2 is dependent only on the thread 1 to its left. The thread 3 in the second row is dependent on thread 1 above it and thread 2 to its upper right. The wavefront is the number of threads that are running at the same time. So the execution sequence is threads 1 and 2, two threads 3, two threads 4 and three threads identified by 5, three threads identified by 6, four threads identified by 7, and four threads 8. So the waves are thread 1, then 2, then 3(2), 4(2), 5(3), 6(3), 7(4), etc.

In this example with 48 total threads, the maximum number of threads that can run concurrently is 4 for thread numbers 7-12 in FIG. 1. And this maximum is reached after a warm-up period near the upper left corner in FIG. 1 of increasing number of threads running at the same time and is followed by a cool-down period of decreasing numbers of threads running at the same time approaching the lower right corner in FIG. 1. The peak concurrent thread number is related to either the width or height of the thread space. The more software threads that are available in the thread space, the more GPU parallelism that can be attained.

Consider the dependency scenario in VP9 deblock module. The lowest granularity deblock operation may be applied on 4×4 pixel block boundary for both vertical and horizontal edges. In VP9, each 64×64 pixel block area is called super block. The data dependency of deblock is determined by the deblock operation ordering. The deblock ordering is as follows. Inside the superblock, firstly all vertical edge's deblock are applied in vertical raster scan order from left to right, and then all horizontal edges deblock are applied in horizontal raster scan order from top to bottom.

FIG. 2 shows an upper left corner (8×8 pixel block) of a VP9 superblock (indicated by shading) with both vertical and horizontal deblock edges. The vertical dashed lines are the threads that process the vertical deblock edges and horizontal dashed lines are the horizontal deblock edges. The shaded portion of the superblock has dependencies above and to the left, as indicated in FIG. 2. So 64 threads are used to handle horizontal edges and 64 threads are used for vertical edges.

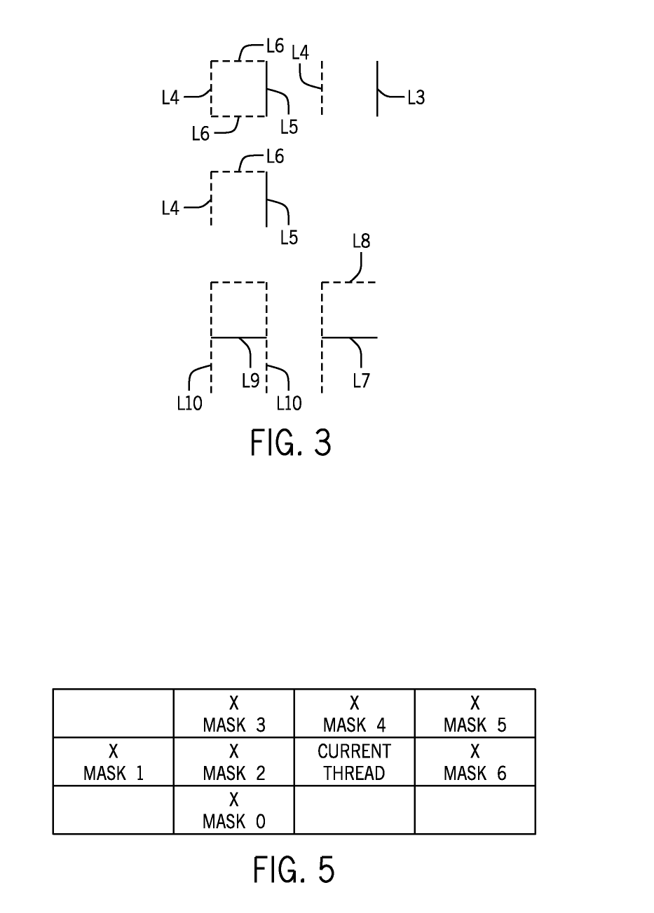

FIG. 3 shows the five default dependencies for both vertical and horizontal edges. The solid lines are dependent edges and the dotted lines are associative or neighboring edges. In general, there is a different dependency pattern based on the different edge spatial positions. The top three images in FIG. 3 illustrate the vertical edge dependencies. The vertical edge operation depends on its left neighbor vertical edge's result, as shown by a solid line L3 with a dotted line L4 to its left. If the vertical edge is on a superblock boundary, it depends on its left superblock neighbor's horizontal edge result as shown by a solid vertical line L5 connected to a dotted horizontal lines L6.

The bottom two images in FIG. 3 illustrate the horizontal edge dependencies. The horizontal edge operation might depend on its top neighbor's horizontal edge result, shown by a solid line L7 with a dotted line L8 above it, as well as its left and right's vertical edge's result, shown by a solid line L9 with dotted vertical lines L10 shown to its side.

The first fundamental idea is to split the larger thread (traditional 64×64 pixel data area per thread) into many smaller threads without “deadlock” (i.e. undeterminable) dependency. To avoid deadlock dependency, the vertical edge operation and horizontal edge operation are put into separate interleaved threads. This is a key reason for doing the split, since otherwise dependency deadlock is unavoidable.

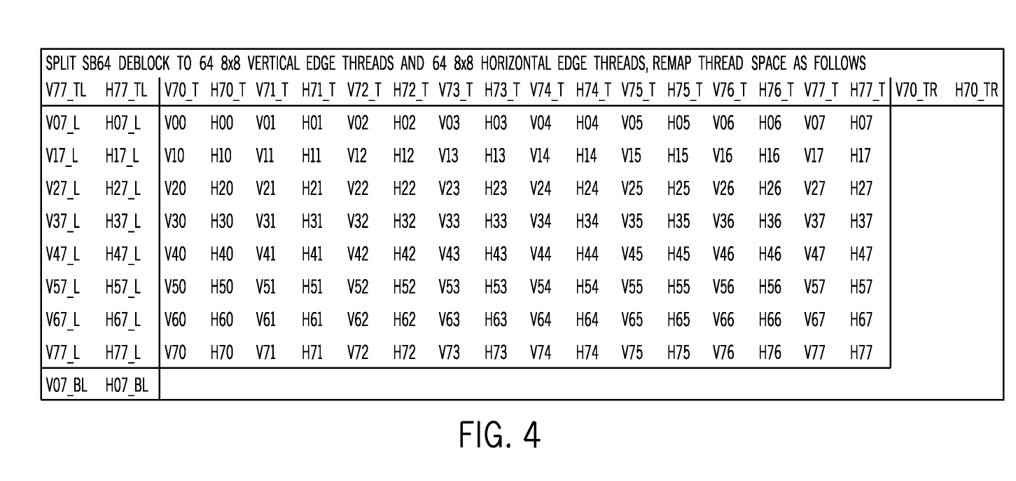

FIG. 4 shows the interleaving of the vertical and horizontal threads where L stands for left, T stands for top, V stands for the threads handling vertical edges only, and H stands for the threads handling horizontal edges only. The numbers are thread number. So V00, H00 are separate threads with different coordinates. For example, consider if the threads shown in FIG. 4 are the top and the left superblock (no_T or _L), then V00 has (x,y) coordinates (0,0) and H00 has (x,y) coordinates (1,0). So V07_L, H07_L is the edge in the next pixel to the left of the pixel V00, H00 in the block being processed.

Splitting the superblock into 128 threads (64 vertical edge threads and 64 horizontal edge threads) is only one example. The ideal number of divisions could be different (i.e. 32 threads, 64 threads, 256 threads, . . . ) and may be based on both hardware platform configuration and driver implementation.

Another fundamental concept is to define 7 dependency candidates with respect to the current thread, and then clear up to four of the unnecessary dependencies. All possible dependencies are listed in FIG. 5. There are 7 dependencies included with lower left thread (Mask0(−1, 1)); the thread two pixels to the left (Mask1(−2, 0)); the thread to the left (Mask2(−1,0)); thread one up and one to the left (Mask3(−1,−1)); thread above (Mask4(0,−1)); thread up one and to the right (Mask5(1, −1)); thread to the right (Mask6(1, 0)), all situated around the “current thread.”

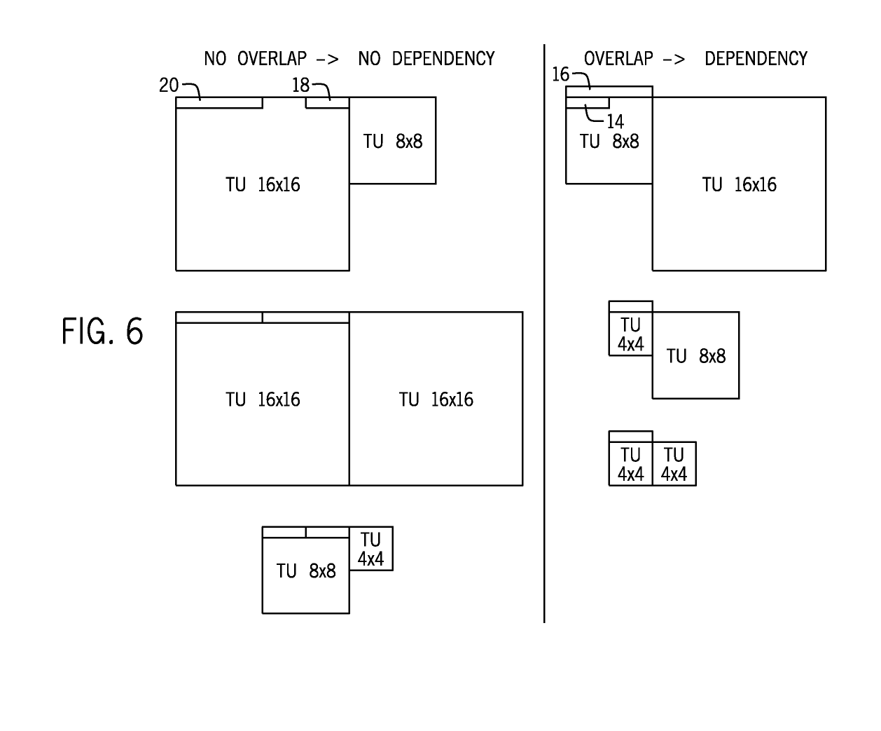

Some content information is helpful to reduce those thread dependencies. Firstly, the block location information can reduce the number of thread dependencies as shown in FIG. 6.

Secondly the transform unit size can be used to further reduce the number of dependencies on the same direction. The transform unit size, specified for each frame, may change from frame to frame. Different transform unit sizes may result in different numbers of dependencies. The horizontal edge thread's dependency on its above neighbor may be cleared and the vertical edge thread's dependency on its left neighbor may also be cleared. Those same directional operation's dependencies are a result of overlapped pixel processing.

In FIG. 6, right part (3 scenarios), there is a 8×8 transform unit to the left of a 16×16 transform unit. There is pixel overlap between row 14 and row 16. The source pixel of row operation 14 must be the pixel revised by row operation 18, so result dependency exists. In FIG. 6 with 8×8 transform unit on the right of the 16×16 transform unit, left part, there is no pixel overlap between row 18 and row 20. The row 20 pixel operation has no result dependency from the row 18 pixel operation.

For transform Unit (TU) of 16×16 or larger size, the deblock might read 8 pixels from each direction (left/right, up/down) and revise 7 pixels on each direction. For TU 8×8, the deblock might read 4 pixels from each direction (left/right, up/down) and revise 3 pixels on each direction. For TU 4×4, the deblock might read 4 pixels from each direction (left/right, up/down) and revise 2 pixels on each direction.

The overlap/dependency for a vertical edge is described in FIG. 6. A similar concept may be applied on the horizontal edge. With this TU size information, one can reduce dependencies from 20% to 40% and improve parallelism based on varied content in some embodiments. As deblock will not happen on the picture/tile boundary, this context can be utilized to further reduce the dependencies.

In some embodiments, instead of always using a given number of threads may be modified. For example by looking at the characteristics of a given frame, the number of threads may be rendered to reduce complexity.

A VP9 kernel may be used to decode a VP9 clip. As a clip is processed, frame by frame, the kernel sees what the transform unit size is, based on encoding within the frame. All seven dependencies are set in hardware or by driver for each thread, in one embodiment. The thread then clears those dependencies that are not needed. For example, 7 registers are set to enforce 7 dependencies that are cleared on write. So if kernel writes to a register, it clears out the dependency enforced by that register. So, at the end, only the dependencies of the uncleared registers are enforced.

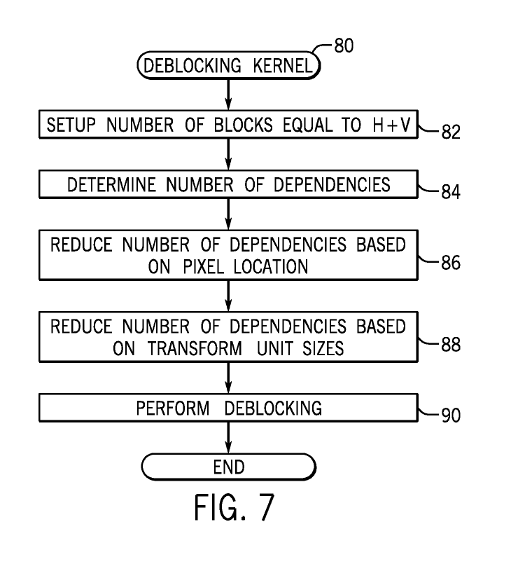

FIG. 7 is a sequence for implementing a decoding kernel according to one embodiment. The sequence 80 may be implemented in software, firmware and/or hardware. In software and firmware embodiments it may be implemented by computer executed instructions stored in one or more non-transitory computer readable media such as magnetic, optical, or semiconductor storages. In some embodiments the deblocking kernel may be part of a video compression/decompression algorithm stored in association with a graphics processing unit.

The kernel 80 shown in FIG. 7 begins by setting up a number of threads equal to the number of horizontal plus the number of vertical rows of pixels as indicated in block 82. Then the number of dependencies may be set as indicated in block 84.

Thus for an example in the VP9 algorithm, the number of threads may be set equal to 64 and the dependencies may be set to 7.

Then the number of dependencies may be reduced based on pixel location as indicated in block 86. Also the number of dependencies may be reduced based on transform sizes as indicated in block 88 in some embodiments. Then the deblocking is performed as indicated in block 90.

For example in some embodiments, a register may be provided for each of the 7 possible dependencies, the register established by default for a given thread. Then the thread itself may examine those dependencies and determine whether or not those dependencies are really needed. For example, when the thread attempts to write to a given register for a given dependency, that dependency is cleared and is no longer enforced.

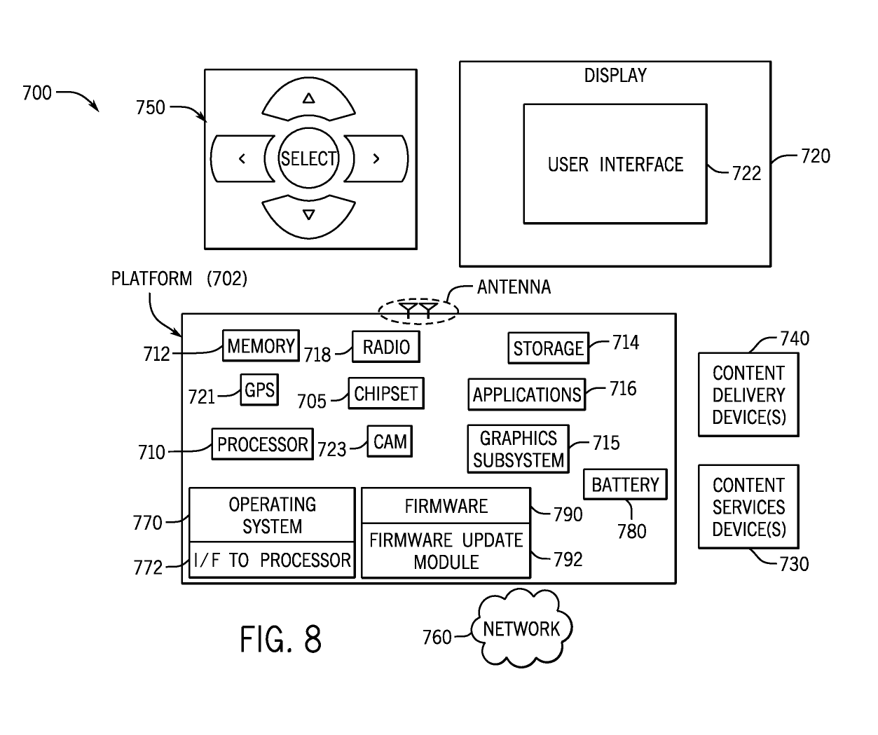

FIG. 8 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth. The processor may implement the sequence of FIG. 7 together with memory 712.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to scope limiting.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 4.

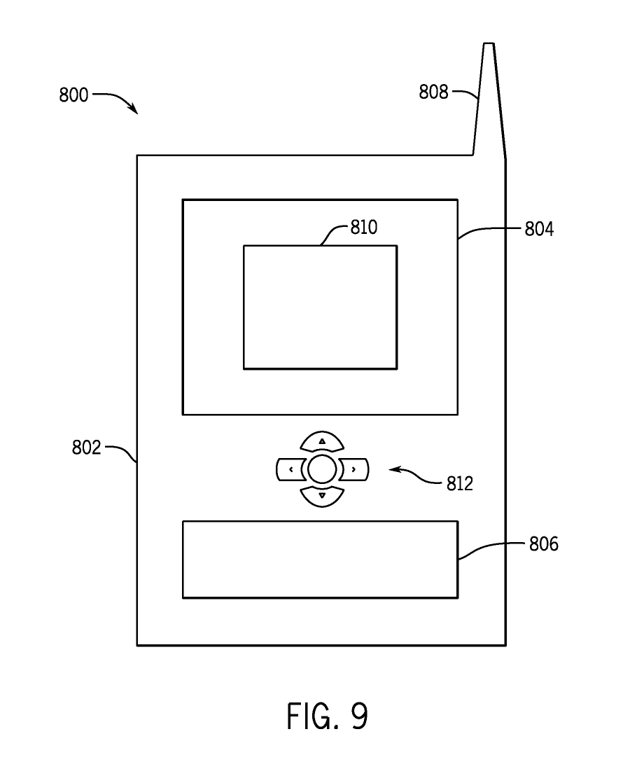

As described above, system 700 may be embodied in varying physical styles or form factors. FIG. 9 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

The processor 710 may communicate with a camera 722 and a global positioning system sensor 720, in some embodiments. A memory 712, coupled to the processor 710, may store computer readable instructions for implementing the sequences shown in FIG. 7 in software and/or firmware embodiments.

As shown in FIG. 9, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

The following clauses and/or examples pertain to further embodiments:

One example embodiment may be a method comprising performing deblocking for video compression by splitting a larger kernel for an entire block into smaller portions with fewer dependencies, and reducing the number of dependencies for a given thread by eliminating unnecessary dependencies. The method may also include using a number of threads equal to the number of rows plus the number of columns of a block size used for video compression. The method may also include reducing unneeded dependencies based on pixel location within the block. The method may also include reducing unneeded dependencies based on transform unit size. The method may also include using a block size of 64×64 pixels or larger. The method may also include assigning seven dependencies per thread and then attempting to reduce the number of dependencies. The method may also include assigning seven dependencies to two threads to the left, one thread to the right, three threads above, and one thread below and to the left of the current thread.

Another example embodiment may be one or more non-transitory computer readable media storing instructions to execute a sequence comprising performing deblocking for video compression by splitting a larger kernel for an entire block into smaller portions with fewer dependencies, and reducing the number of dependencies for a given thread by eliminating unnecessary dependencies. The media may include using a number of threads equal to the number of rows plus the number of columns of a block size used for video compression. The media may include reducing unneeded dependencies based on pixel location within the block. The media may include reducing unneeded dependencies based on transform unit size. The media may include using a block size of 64×64 pixels or larger. The media may include assigning seven dependencies per thread and then attempting to reduce the number of dependencies. The media may include assigning seven dependencies to two threads to the left, one thread to the right, three threads above, and one thread below and to the left of the current thread.

In another example embodiment may be an apparatus comprising a processor to perform deblocking for video compression by splitting a larger kernel for an entire block into smaller portions with fewer dependencies, and reduce the number of dependencies for a given thread by eliminating unnecessary dependencies, and a storage coupled to said processor. The apparatus may include said processor to use a number of threads equal to the number of rows plus the number of columns of a block size used for video compression. The apparatus may include said processor to reduce unneeded dependencies based on pixel location within the block. The apparatus may include said processor to reduce unneeded dependencies based on transform unit size. The apparatus may include said processor to use a block size of 64×64 pixels or larger. The apparatus may include said processor to assign seven dependencies per thread and then attempting to reduce the number of dependencies. The apparatus may include said processor to assign seven dependencies to two threads to the left, one thread to the right, three threads above, and one thread below and to the left of the current thread. The apparatus may include a display communicatively coupled to the circuit. The apparatus may include a battery coupled to the circuit. The apparatus may include firmware and a module to update said firmware.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

What is claimed is:

1. A method comprising:
performing deblocking for video compression by splitting a larger kernel for an entire block into smaller portions with fewer dependencies; and
reducing the number of dependencies for a given thread by eliminating unnecessary dependencies.

2. The method of claim 1 including using a number of threads equal to the number of rows plus the number of columns of a block size used for video compression.

3. The method of claim 1 including reducing unneeded dependencies based on pixel location within the block.

4. The method of claim 1 including reducing unneeded dependencies based on transform unit size.

5. The method of claim 1 including using a block size of 64×64 pixels or larger.

6. The method of claim 1 including assigning seven dependencies per thread and then attempting to reduce the number of dependencies.

7. The method of claim 6 including assigning seven dependencies to two threads to the left, one thread to the right, three threads above, and one thread below and to the left of the current thread.

8. One or more non-transitory computer readable media storing instructions to execute a sequence comprising:
performing deblocking for video compression by splitting a larger kernel for an entire block into smaller portions with fewer dependencies; and
reducing the number of dependencies for a given thread by eliminating unnecessary dependencies.

9. The media of claim 8, said sequence including using a number of threads equal to the number of rows plus the number of columns of a block size used for video compression.

10. The media of claim 8, said sequence including reducing unneeded dependencies based on pixel location within the block.

11. The media of claim 8, said sequence including reducing unneeded dependencies based on transform unit size.

12. The media of claim 8, said sequence including using a block size of 64×64 pixels or larger.

13. The media of claim 8, said sequence including assigning seven dependencies per thread and then attempting to reduce the number of dependencies.

14. The media of claim 13, said sequence including assigning seven dependencies to two threads to the left, one thread to the right, three threads above, and one thread below and to the left of the current thread.

15. An apparatus comprising:
a processor to perform deblocking for video compression by splitting a larger kernel for an entire block into smaller portions with fewer dependencies, and reduce the number of dependencies for a given thread by eliminating unnecessary dependencies; and
a storage coupled to said processor.

16. The apparatus of claim 15, said processor to use a number of threads equal to the number of rows plus the number of columns of a block size used for video compression.

17. The apparatus of claim 15, said processor to reduce unneeded dependencies based on pixel location within the block.

18. The apparatus of claim 15, said processor to reduce unneeded dependencies based on transform unit size.

19. The apparatus of claim 15, said processor to use a block size of 64×64 pixels or larger.

20. The apparatus of claim 15, said processor to assign seven dependencies per thread and then attempting to reduce the number of dependencies.

21. The apparatus of claim 20, said processor to assign seven dependencies to two threads to the left, one thread to the right, three threads above, and one thread below and to the left of the current thread.

22. The apparatus of claim 15 including a display communicatively coupled to the circuit.

23. The apparatus of claim 15 including a battery coupled to the circuit.

24. The apparatus of claim 17 including firmware and a module to update said firmware.
